(19) United States
(12) Patent Application Publication
(10) Pub. No.: US 2014/0008283 A1
(43) Pub. Date: Jan. 9, 2014

(54) CONDUIT FILTER

(71) Applicant: C.I. Agent Storm-Water Solutions LLC, Louisville, KY (US)

(72) Inventors: Donald Eugene Mabe, Huntington Beach, CA (US); Brent Hepner, Maple Valley, WA (US)

(73) Assignee: C.I. Agent Storm-Water Solutions LLC, Louisville, KY (US)

(21) Appl. No.: 13/937,265

(22) Filed: Jul. 9, 2013

Related U.S. Application Data
(60) Provisional application No. 61/669,514, filed on Jul. 9, 2012.

(51) Int. Cl. C02F 1/40

(52) U.S. Cl. CPC C02F 1/40
USPC 210/282; 210/459

(57) ABSTRACT

A filter has a sealing portion and a filtering portion coupled to the sealing portion. The sealing portion is configured to form a seal with an inner surface of a conduit to inhibit the liquid from passing through the conduit outside of the filter assembly. Further, the sealing portion has a passage therethrough to permit the liquid to pass through the sealing portion into the filtering portion. The filter also has any combination of one or more of the following characteristics: (i) the filter is installable flush with or entirely below the inlet of the conduit, (ii) the filter has an oil-solidifying substance that solidifies oils, such as hydrocarbons, passing through the filter, and (iii) the filter has an oleophobic and hydrophilic substance that inhibits oils from passing through the filtering portion.

### CROSS-REFERENCE TO RELATED APPLICATIONS

This application claims the benefit of the filing date of U.S. provisional application No. 61/669,514, filed on Jul. 9, 2012 as attorney docket no. 504024111 under 35 U.S.C. 119(e), the disclosure of which is incorporated herein by reference in their entirety.

### BACKGROUND

1. Field of the Invention

The present invention relates to filtering liquids, and, more specifically but not exclusively, to filtering liquids flowing through conduits such as drains.

2. Description of the Related Art

Ships, boats, and other vessels traveling over bodies of water typically comprise drains, commonly referred to as scuppers, to release liquids present on their decks into the bodies of water below. Each drain is typically a passage that extends from the deck or an inner surface of the hull of a vessel to an outer surface of the hull of the vessel. By law, any liquid draining into the body of water below must meet certain environmental standards. Therefore, the liquid must be filtered to remove contaminants such as sediments, debris, and chemicals before draining the liquid into the body of water below. If filtering the liquid is impossible or is impractical, then the drain or drains must be plugged, preventing the liquid from being released into the body of water altogether.

Filtration systems have been used to filter liquids present on vessels. However, these filtration systems are commonly implemented on the decks of vessels, creating tripping hazards for the crew of the vessel. Further, these filtration systems commonly require continuous monitoring to insure that the filtration systems work and the contaminants do not bypass the filtration systems.

### SUMMARY

In one embodiment, a filter assembly that is configured to filter a liquid entering a conduit comprises (i) a sealing portion and (ii) a filtering portion coupled to the sealing portion. The sealing portion is configured to form a seal with an inner surface of the conduit to inhibit the liquid from passing through the conduit outside of the filter assembly. Further, the sealing portion has a passage therethrough to permit the liquid to pass through the sealing portion into the filtering portion. The filtering portion is configured to allow water to pass through the filtering portion and comprises at least one of: (i) an oil-solidifying substance and (ii) a hydrophilic and oleophobic substance configured to inhibit oil from passing through the filtering portion.

In another embodiment, a filter assembly that is configured to filter a liquid entering a conduit comprises (i) a sealing portion and (ii) a filtering portion that is coupled to the sealing portion and configured to inhibit oil from passing through the filtering portion. The sealing portion has a passage therethrough to permit the liquid to pass through the sealing portion into the filtering portion. Further, the sealing portion has a sealing edge configured to form a seal with an inner surface of the conduit to inhibit the liquid from passing through the conduit outside of the filter assembly, wherein the sealing portion has a cross-sectional area at the sealing edge. The filter assembly is configured to fit entirely within a space having a cross-sectional area that is less than or equal to the cross-sectional area at the sealing edge.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a perspective view of an assembled drain filter according to one embodiment of the disclosure;

FIG. 2 shows an exploded perspective view of the parts of the drain filter of FIG. 1;

FIG. 3 shows a simplified cutaway view of a portion of a vessel having a drain with the drain filter of FIG. 1 installed therein;

FIG. 4 shows a perspective view of a portion of a drain filter and an installation tool according to one embodiment of the disclosure that may be used to install the drain filter of FIG. 1 into the drain of FIG. 3;

FIG. 5 shows a perspective view of an assembled drain filter according to another embodiment of the disclosure; and

FIG. 6 shows an exploded perspective view of the parts of the drain filter of FIG. 5.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

The present disclosure relates to drain filters configured to filter liquids passing through drains Embodiments of the disclosure may have any combination of one or more of the following characteristics: (i) the drain filter is installable flush with or entirely below the inlet of the drain, (ii) the drain filter has an oil-solidifying substance that solidifies oils, such as hydrocarbons, passing through the filter, and (iii) the drain filter has an oleophobic and hydrophilic substance that inhibits oil from flowing through the drain filter.

In general, as used herein, the term “oil” refers to a neutral, nonpolar chemical substance, that is a viscous liquid at ambient temperatures, and is immiscible with water but soluble in alcohols or ethers. The oils that may be solidified and/or inhibited by embodiments of the disclosure include, but are not limited to, any of the base oils in Groups I-V as specified in the American Petroleum Institute (API) Base Oil Interchangeability Guidelines. The five base oil groups are as follows:

TABLE 1

| Base oil | | | Saturates | Viscosity |
|---|---|---|---|---|
| Category | Sulfur (%) | | (%) | Index |
| Group I | >0.03 | and/or | <90 | 80 to 120 |
| Group II | ≦0.03 | and | ≧90 | 80 to 120 |
| Group III | ≦0.03 | and | ≧90 | ≧120 |
| Group IV | All polyalphaolefins | | | |
| | (PAOs) | | | |
| Group V | All others not | | | |
| | included in Groups | | | |
| | I, II, III, or IV | | | |

Groups I, II, and III are mineral oil process stocks. Group IV base oils contain true synthetic molecular species, which are produced by polymerization of olefinically unsaturated hydrocarbons. Many Group V base oils are also true synthetic products and may include diesters, polyol esters, polyalkylene glycols, alkylated aromatics, polyphosphate esters, polyvinyl ethers, and/or polyphenyl ethers, and the like, but may also be naturally occurring oils, such as vegetable oils as well as crude oils such as light crude oil and naphtha. It should be noted that although Group III base oils are derived from mineral oil, the rigorous processing that these fluids undergo causes their physical properties to be very similar to some true synthetics, such as PAOs. Therefore, oils derived from Group III base oils may sometimes be referred to as synthetic fluids in the industry.

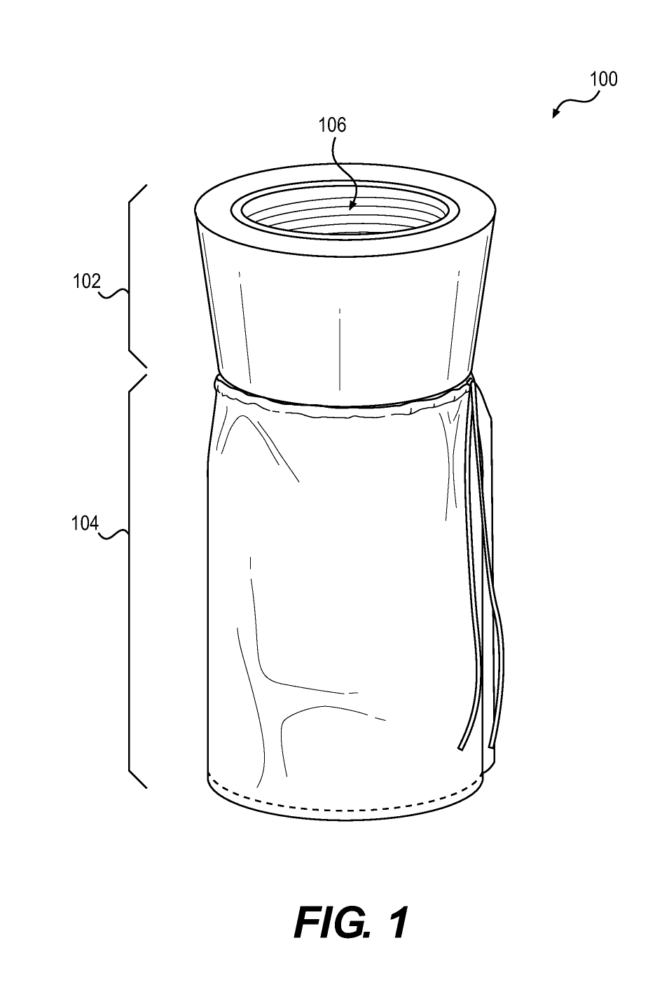

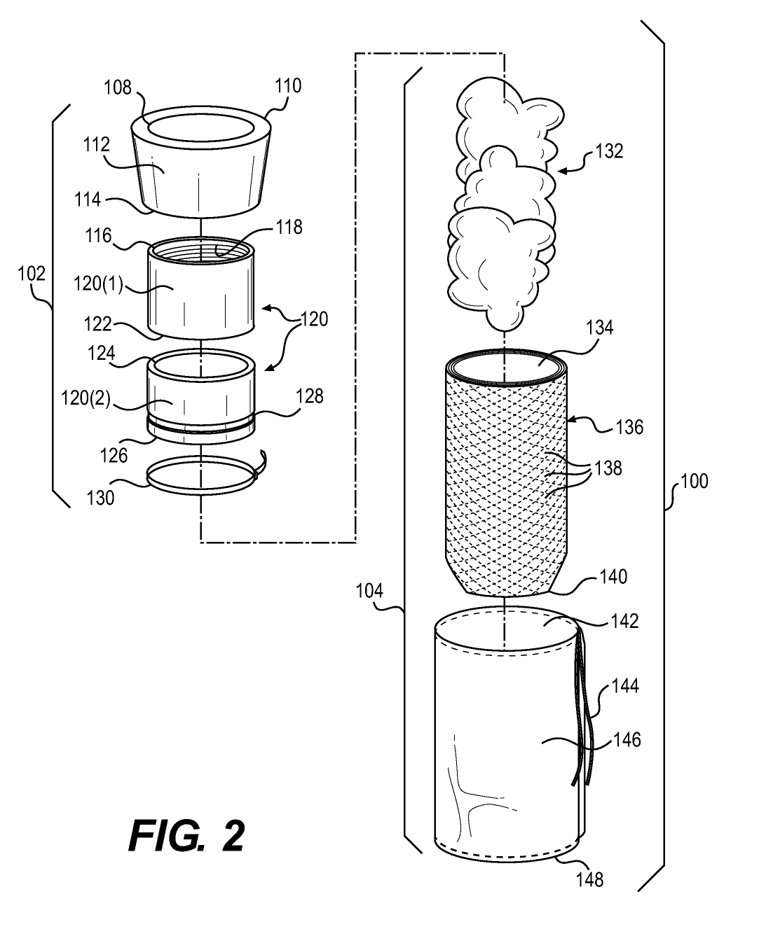

FIG. 1 shows a perspective view of an assembled drain filter 100 according to one embodiment of the disclosure, and FIG. 2 shows an exploded perspective view of the parts of drain filter 100. As will be described below, drain filter 100 is an example of one embodiment of the disclosure that (i) is installable flush with or entirely below the inlet of a drain and (ii) has an oil-solidifying substance that solidifies oil passing through the filter. Drain filter 100 has a sealing portion 102 and a filtering portion 104 that is secured to sealing portion 102 as described in further detail below.

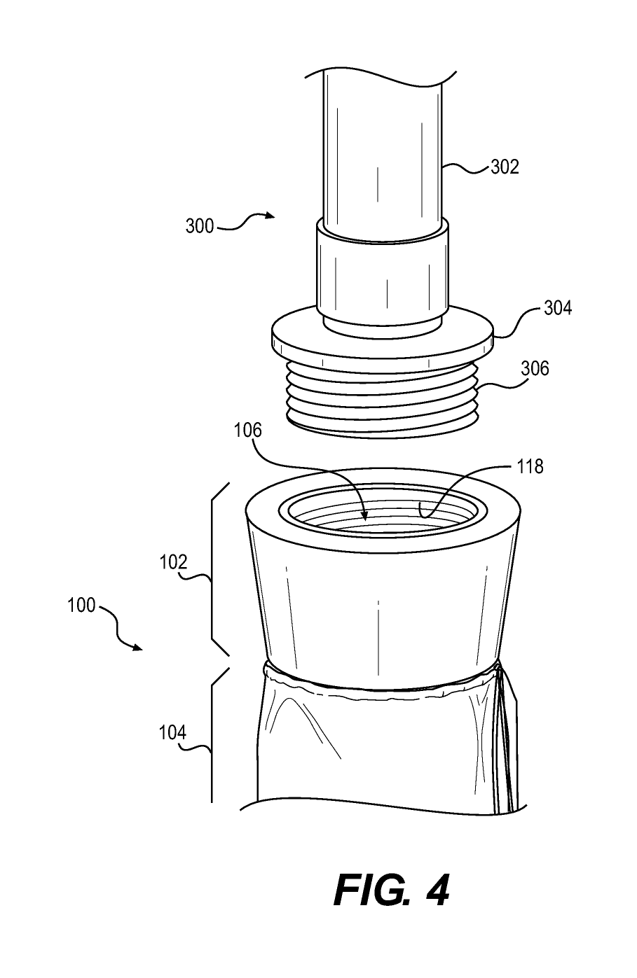

Sealing portion 102 has a rigid seal body 120 and a compressible seal 112. Seal body 120 has a first part 120(1) and a second part 120(2), which may be fabricated from any suitable rigid material or materials such as plastics, metals, fiberglass, etc. Note that, in alternative embodiments of the disclosure, seal body 120 may also be fabricated as a single part. First part 120(1) of seal body 120 has a generally tubular shape with an inlet side 116 oriented toward an inlet 106 of drain filter 100 and an outlet side 122 oriented toward filtering portion 104 of filter 100. Female threads 118 are formed on the inner surface of inlet side 116 to support the use of a tool (shown in FIG. 4) in installing drain filter 100 into, and removing drain filter 100 from, a drain.

Second part 120(2) also has a generally tubular shape with an inlet side 124 oriented toward inlet 106 of filter 100 and an outlet side 126 oriented toward filtering portion 104. The outer diameter of second part 120(2) is sized to permit the inlet side 124 of second part 120(2) to fit into the outlet side 122 of first part 120(1). First and second parts 120(1) and 120(2) may be secured together using, for example, an interference fit and/or an adhesive that bonds the parts together. Second part 120(2) also has a groove 128 formed therein that accepts zip-tie 130 when securing filtering portion 104 to sealing portion 102.

Seal 112 is formed from a sealing material suitable for creating a seal with a rigid surface, such as an elastomer (e.g., polyurethane). Seal 112 has an inlet side 108 and an outlet side 114. Inlet side 108 has an outer diameter that is larger than the outer diameter of outlet side 114 such that seal 112 may have, for example, a generally conical outer shape. As will be discussed below, inlet side 108 has sealing edge 110, which establishes a seal with the drain to prevent liquid from bypassing drain filter 100. A cylindrically-shaped passage is formed through seal 112, and the diameter of the passage is sized such that seal 112 may be installed on the outer surface of first part 120(1). Seal 112 and first part 120(1) may be secured together using, for example, an interference fit and/or an adhesive, or by molding seal 112 directly to first part 120(1). Seal 112 and first part 120(1) may also be formed integrally with one another as a single part. Although not shown, when first part 120(1), second part 120(2), and seal 112 are assembled together, outlet side 126 of second part 120(2) protrudes from first part 120(1) and seal 112, such that groove 128 is exposed, allowing zip-tie 130 to be mated therewith.

Filtering portion 104 comprises an inner filter 132, an outer filter 136, and a protective cover 146. Inner filter 132 holds sediment and debris away from the walls of outer filter 136. Further, inner filter 132 may be constructed using a non-oil-solidifying, hydrophobic, and oleophilic substance that has an affinity for oils but not water, thereby slowing the passage of oils to the walls of outer filter 136 and allows water to flow freely to the walls of outer filter 136. For example, inner filter material 132 may be a fill of polyester fibers or a sorbent such as those discussed below.

Outer filter 136 is a bag-like structure having an open inlet side 134 and an outlet side 140 that is sewn or otherwise fastened closed. Outer filter 136 is constructed from two or more layers of a hydrophobic fabric, such as, for example, polyester or polypropylene, that permits the passage of water through the fabric. The two or more layers of fabric are sewn together in a quilted manner such that a plurality of pockets 138 are formed around part or all of the surface of outer filter 136. In FIG. 2, each of the plurality of pockets 138 is shown as a diamond shape or partial diamond shape on outer filter 136. The pockets are filled with an oil-solidifying substance that may assume any suitable form, including, but not limited to, dry powder, granules, and semi-solid materials.

There are at least three different types of oil-solidifying substances, including polymer sorbents, cross-linking agents, and polymers with cross-linking agents. Polymer sorbents, sometimes called super-sorbents, adsorb oil into spaces between polymers, and oil is held in these spaces by van der Waals forces, which are weak attraction forces between molecules. Examples of polymers that are capable of being solidifiers include, block co-polymers such as styrene butadiene and related polymers, poly-tertiary-butyl-styrene, polyacrylo-nitrile butadiene, polyisoprene (rubber), polyethylene and polypropylene, poly isobutylene and related polymers.

Cross-linking agents are chemical products that form chemical bonds between two hydrocarbons to solidify the oil. The reaction is that of a chemical one and typically can release a small amount of heat or absorb that amount of heat depending on the chemical used. Examples of cross-linking agents include norbornene, anhydrides, and a series of oil treating agents created by Pelletier and Siron (1999) that are prepared by reacting surfactants, alcohols or carboxylic acids with alkychlorosilanes in light hydrocarbon solvents.

Polymers with cross-linking agents also form chemical bonds. These types of solidifiers combines a polymeric sorbent with a cross-linking agent, and the purpose of this combination is to gain the advantages of both polymers and cross-linking agents. An example of this type of solidifier includes a product called RigidOil by British Petroleum. The agent consists of two liquids which are generally mixed shortly before applying to the oil. The one liquid consists of a 10% maleinized polybutadiene of molecular weight 8000 with 50% of odorless kerosene plus ester, as a diluent. The other liquid consists of a cross-linking agent, zinversate diethanolamine also in 50% kerosene/ester (9:1).

A general description of polymer-based oil-solidifying substances may be found in the Environmental Protection Agency's (EPA's) National Response Team (NRT) and Regional Response Team (RRT) factsheet entitled “Application of Sorbents and Solidifiers for Oil Spills” (February 2007), and a description of the three above-mentioned oil-solidifying substances may be found in Fingas, “A Review of Literature Related to Oil Spill Solidifiers 1990-2008” (September 2008), the teachings of both of which are incorporated herein by reference in their entirety.

Protective cover 146 is also a fabric bag-like structure having an open inlet side 142 and an outlet side 148 that is sewn or otherwise fastened closed. At inlet side 142, protective cover 146 has a drawstring 144, which is used to secure protective cover 146 to sealing portion 102. Protective cover 146 protects the quilted pockets of outer filter 136 from damage, and may be constructed of a suitable hydrophobic fabric that allows water to pass, including, but not limited to, polyester and polypropylene. The hydrophobic fabric may also aid in contaminant removal, and may remove contaminants smaller in size than those removed by inner filter 132 and outer filter 136 to provide a further filtration, if desired.

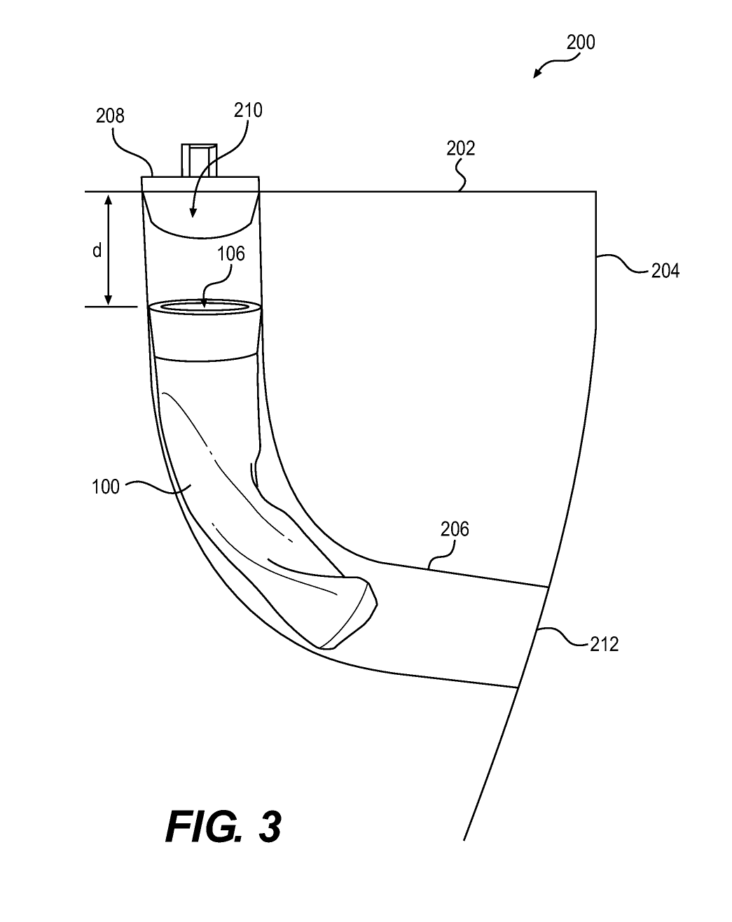

To assemble drain filter 100, sealing portion 102 is assembled as described above. Inner filter 132 is located inside outer filter 136, and the outlet side 126 of second part 120(2) of seal 112 and is inserted into the inlet side 134 of outer filter 136. Outer filter 136 is fastened to sealing portion 102 by wrapping a zip-tie 130 around the inlet side 134 of outer filter 136, mating the two ends of zip-tie 130, and tightening zip-tie 130 around outer filter 136 such that zip-tie 130 depresses material of outer filter 136 into groove 128 of seal body 120. Finally, protective cover 146 is slid over outer filter 136 and drawstring 144 of protective cover 146 is tightened into groove 128. To further understand the operation of drain filter 100, consider FIG. 3.

FIG. 3 shows a simplified cutaway view of a portion of a vessel 200 having a drain 206 with drain filter 100 installed therein. Drain 206 is a passage that extends from deck 202 of vessel 200 to the outer surface of hull 204 of vessel 200. Drain 206 has a generally cylindrical shape with an approximately 90 degree bend.

Drain filter 100 is installed within drain 206 such that inlet 106 of drain filter 100 is oriented toward inlet 210 of drain 206. Further, drain filter 100 may be installed such that inlet 106 of drain filter 100 is (i) flush with deck 202 or (ii) at a distance d below deck 202. As shown in FIG. 3, distance d may be selected such that drain plug 208 or a drain gate (not shown) can be installed in drain 206 when drain filter 100 is also installed in drain 206. Installation flush with or below deck 202 is made possible by the fact that every portion of drain filter 100 has a cross-sectional area (or may be compressed within a cross-sectional area) that is less than or equal to the cross-sectional area within sealing edge 110 of sealing portion 102. Installing drain filter 100 so that it is flush with deck 202 or installed completely below deck 202 prevents drain filter 100 from being a tripping hazard to crewmembers of vessel 200 working on deck 202.

When drain filter 100 is installed in drain 206, sealing edge 110 of seal 112 compresses between the outer surface of sealing body 120 and the inner surface of drain 206 to inhibit liquid from passing between seal 112 and the inner surface of drain 206. Initially, as gravity pulls liquid from deck 202 into drain 206, the liquid is permitted to flow freely through inlet 106 of drain filter 100 and into filtering portion 104 of drain filter 100. When drain filter 100 first receives a liquid, any water present in the liquid should flow through inner filter 132, outer filter 136, and protective cover 146 to the outlet 212 of drain 206 with minimal resistance. Note that the water may pass through any surface of protective cover 146, not just the surface closest to outlet 212 of drain 206. Sediments, debris and other contaminants, and optionally, oils, on the other hand, should be slowed considerably by inner filter 132. In fact, the material used to implement inner filter 132 may be chosen such that inner filter 132 slows down the passage of oil long enough to give the oil-solidifying substance in the pockets of outer filter 136 sufficient time to solidify oil present in the liquid.

As time passes and the amount of oil solidified by drain filter 100 increases, the solidified oil will eventually completely block filtering portion 104, causing drain filter 100 to shut off. This may occur before or at that time that the oil-solidifying effect of the oil-solidifying substance is exhausted. As a result, all liquid, including water, will be prevented from passing to outlet 212 of drain 206. Thus, drain filter 100 may be considered to be a fail close filter. Before or after drain filter 100 shuts off, drain filter 100 can be replaced, and the solidified oil within drain filter 100 can be recycled as a fuel source.

FIG. 4 shows a perspective view of a portion of drain filter 100 and an installation tool according to one embodiment of the disclosure that may be used to install drain filter 100 into drain 206. Installation tool 300 has (i) a shaft 302 that is fabricated using a pipe or a pole and (ii) an attachment portion 304, which has male threads 306 formed thereon. Shaft 302 and attachment portion 304 are secured to one another to ensure that they rotate in unison.

To install drain filter 100 into, or remove drain filter 100 from, drain 206, installation tool 300 is secured to drain filter 100 by inserting attachment portion 304 into inlet 106 of drain filter 100 and turning shaft 302 such that such that male threads 306 of installation tool 300 are rotated into female threads 118 of drain filter 100. Once installation tool 300 and drain filter 100 are secured to one another, drain filter 100 is installed by using installation tool 300 to press drain filter 100 into drain 206 or removed by using installation tool 300 to pull drain filter 100 out of drain 206. Once installation or removal is complete, installation tool 300 is detached from drain filter 100 by de-rotating attachment portion 304 out of sealing body 120 of drain filter 100.

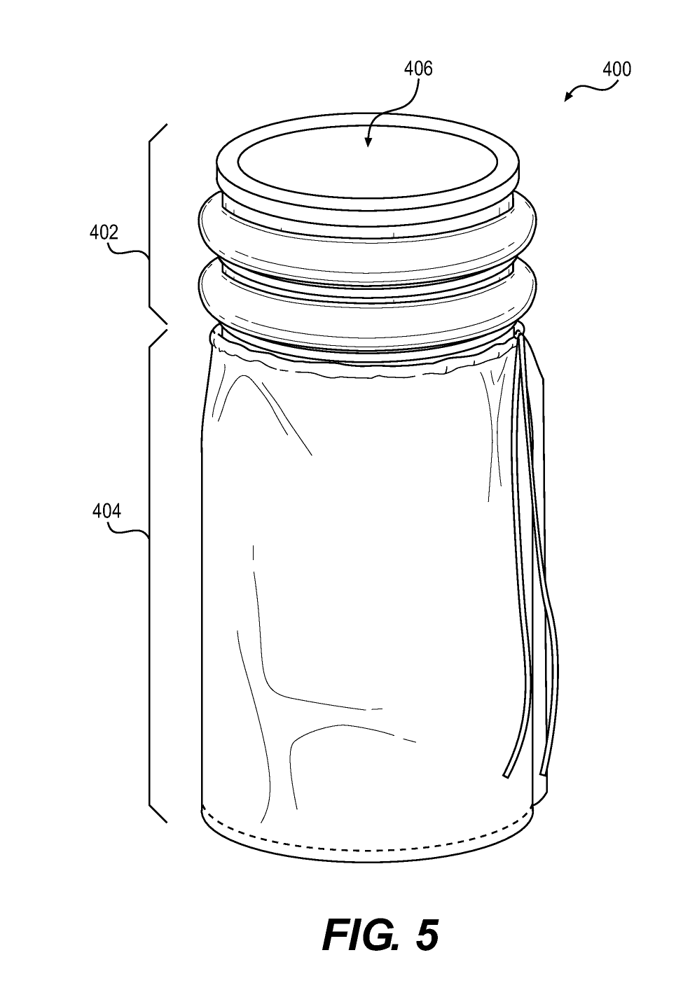

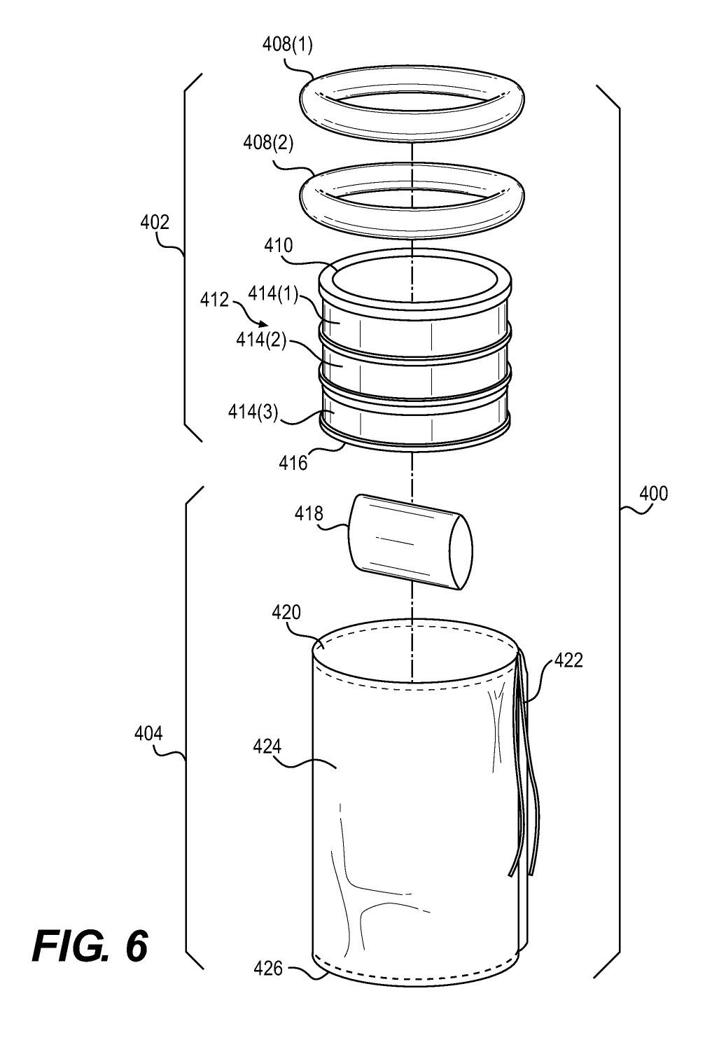

FIG. 5 shows a perspective view of an assembled drain filter 400 according to another embodiment of the disclosure, and FIG. 6 shows an exploded perspective view of the parts of drain filter 400. Drain filter 400 may be used in a drain such as drain 206 in FIG. 3. As will be described below, drain filter 400 is an example of one embodiment of the disclosure that (i) is installable flush with or entirely below the inlet of the drain, (ii) has an oil-solidifying substance that solidifies oil passing through the filter, and (iii) has a oleophobic and hydrophilic substance that inhibits oil from flowing out through drain filter 400. Similar to drain filter 100, drain filter 400 has a sealing portion 402 and a filtering portion 404 that is secured to sealing portion 402.

Sealing portion 402 has a rigid seal body 412 and two compressible seals 408(1) and 408(2). Seal body 412, which may be fabricated from any suitable rigid material or materials such as plastics, metals, fiberglass, etc., has a generally tubular shape with three grooves 414(1)-(3) formed on the outer surface thereof. Although not shown, female threads may be formed on the inner surface of inlet side 410 of seal body 412 to support the use of installation tool 300 in FIG. 4.

Seals 408(1) and 408(2) may be, for example, O-rings formed from a sealing material suitable for creating a seal with a rigid surface, such as an elastomer (e.g., polyurethane). As shown in FIG. 5, seals 408(1) and 408(2) rest inside grooves 408(1) and 408(2) when installed.

Filtering portion 404 has inner filter 418 and outer filter 424. Inner filter 418 is a pillow-shaped fabric pouch constructed using, for example, an oleophilic and hydrophobic fabric such as polyester or polypropylene, that is filled with an oil-solidifying substance, such as any of those described above in relation to FIGS. 1 and 2. Outer filter 424 is a bag-like structure constructed using an oleophobic and hydrophilic fabric. The inlet side 420 of outer filter 424 is open, and the outlet side 426 of outer filter 424 is sewn or otherwise fastened closed.

In at least some embodiments, the oleophobic and hydrophilic fabric of outer filter 424 may be a superoleophobic and superhydrophilic fabric such as any of those described in U.S. patent application publication no. 2011/0303620, the teachings of which are incorporated herein by reference in their entirety. As described in U.S. patent application publication no. 2011/0303620, a superoleophobic and superhydrophilic fabric may be a fabric such as cotton, polyester, leather, or other suitable fabric that is coated with a chemical. The chemical may have a composition comprising at least one oleophobic section (typically flurocarbon groups) and one hydrophilic section (typically groups that possess positive or negative charges in an aqueous solution). The chemical can be either synthesized or commercially available. In at least some embodiments, the chemical composition comprises mono phosphate ester and bis phosphate ester. Further, in at least some embodiments, the oleophobic and hydrophilic fabric separates at least 95% of oil contaminate from water.

To assemble drain filter 400, sealing portion 402 is assembled by orienting O-rings 408(1) and 408(2) inside grooves 414(1) and 414(2) of seal body 412 as described above. Inner filter 418 is placed within outer filter 424, and inner filter 418 rests inside outer filter 424 via gravity. The outlet side 416 of seal body 412 is inserted into the inlet side 420 of outer filter 424, and outer filter 424 is secured to seal body 412 by tightening drawstring 422, such that inlet side 420 of outer filter 424 is pulled into groove 414(3).

Drain filter 400 may be installed into a drain in a manner similar to that shown for drain filter 100 in FIG. 3 (e.g., flush with or at a distance d below the deck of the vessel). Initially, when drain filter 400 is installed and no liquid is flowing into drain filter 400, inner filter 418 rests at the bottom of outer filter 424 due to gravity. As liquid rushes into drain filter 400, the force of the liquid flowing into drain filter 400 further forces inner filter 418 against the bottom of outer filter 424. However, as outer filter 424 fills up and the force of the flowing liquid is relieved, inner filter 418 may float toward inlet 406 of drain filter 400. Note that inner filter 418 must be restrained in some manner to prevent inner filter 418 from floating out of drain filter 400 in the event that liquid is pooling above drain filter 400. For example, inner filter 418 may be tethered to the bottom of outer filter 424 with a string. As another example, inlet 406 may be fitted with a screen to retain inner filter 418 while allowing liquid to pass into filter 400. As yet another example, inner filter 418 may be sized such that it is larger than the opening formed by inlet 406.

In addition, as the force of the flowing liquid is relieved, any oil present in the liquid separates from any water present in the liquid, such that the oil floats upward toward inlet 406 of drain filter 400 and the water sinks down toward outlet 426 of drain filter 400. The oleophobic properties of outer filter 424 inhibit the flow of oil through the surfaces of outer filter 424 to the outlet of the drain, and the hydrophilic properties of outer filter 424 permits the water to pass through all of its surfaces to the outlet of the drain. Preferably, outer filter 424 inhibits the flow of oil for a duration of time that is based on the oil-solidifying effect of the oil-solidifying substance housed in inner filter 418. For example, in some embodiments, outer filter 424 inhibits the flow of oil until the oil-solidifying effect of the oil-solidifying substance is completely exhausted.

Due to the relatively small size of inner filter 418, the amount of oil that drain filter 400 can solidify is less than that of drain filter 100. As a result, unlike like drain filter 100, drain filter 400 does not shut off when or before the oil-solidifying effect of the oil-solidifying substance housed in inner filter 418 is exhausted. Thus, drain filter 100 is more suitable for filtering larger oil spills than drain filter 400.

However, on the other hand, the oleophobic and hydrophilic outer filter 424 of drain filter 400 permits water to flow at a higher rate to the drain outlet than the oil-solidifying-substance-filled pockets of outer filter 136 of drain filter 100. Therefore, drain filter 400 permits a higher flow rate than drain filter 100 and is more suitable for filtering smaller amounts of oil, such as an oil sheen off of the deck of a vessel.

As described above, various embodiments of the present disclosure may have any combination of one or more of the following characteristics: (i) the drain filter is installable flush with or entirely below the inlet of the drain, (ii) the drain filter has an oil-solidifying substance that solidifies oil passing through the filter, and (iii) the drain filter has an oleophobic and hydrophilic substance that inhibits oil from flowing through the drain filter. As illustrated by inner filter 132 of drain filter 100 of FIG. 1, embodiments of the disclosure may also have a non-oil-solidifying sorbent (i.e., adsorbent and/or absorbent) such as those discussed in the EPA's NRT and RRT factsheet entitled “Application of Sorbents and Solidifiers for Oil Spills” (February 2007) that adsorbs and/or absorbs oil in addition to the combination of one or more of the foregoing characteristics. In fact, embodiments of the disclosure may have a non-oil-solidifying sorbent that adsorbs and/or absorbs oil in lieu of an oil-solidifying substance, wherein the embodiments of the disclosure further have one or more of the following characteristics: (i) the drain filter is installable flush with or entirely below the inlet of the drain and (ii) the drain filter has a oleophobic and hydrophilic substance that inhibits the flow of oil relative to the flow of water.

Although embodiments of the disclosure were described relative to their use with drains, embodiments of the disclosure are not so limited. Embodiments of the disclosure may be used with any suitable conduit, including pipes, tubes, channels, and drains. Further such conduits may include open passageways such as gutters and troughs.

Although embodiments of the disclosure were described relative to their use with ships, boats, and other vessels traveling over water, embodiments of the disclosure are not so limited. Embodiments of the disclosure may be used with any suitable drain. For example, embodiments of the disclosure may be used with roof drains, industrial facility floor drains, overpass and bridge drains, etc.

Although two embodiments of the disclosure were shown as having seals that seal to drains having generally circular cross-sections, embodiments of the disclosure are not so limited. Various embodiments of the disclosure may be formed with seals that seal to drains having non-circular cross-sections, including but not limited to, square, rectangular, and oval cross-sections.

Although drain filter 400 in FIG. 5 was shown as having two O-ring seals 408(1) and 408(2), embodiments of the disclosure are not so limited. Alternative embodiments of the disclosure may have one or more O-rings. Preferably, the size and materials of the seal or seals are selected to prevent leakage around the seal or seals when the drain filter is under the worst case pressure head that that the filter may experience.

Although not shown, embodiments of the disclosure similar to drain filter 400 may be implemented with an additional inner filter similar to inner filter 132 in FIG. 2. The additional inner filter may filter contaminants other than oil from the liquid. Further, the additional filter may also be hydrophobic and oleophilic. In such embodiments, the hydrophobic and oleophilic inner filter would trap oil thereby slowing down the passage of oil to the outer surfaces of outer filter 424, and hydrophilic and oleophobic outer filter 424 would act to keep oil that does reach its outer surfaces contained within the drain filter. Thus, together, the hydrophobic and oleophilic inner filter and hydrophilic and oleophobic outer filter 424 may give the oil-solidifying substance in inner filter 418 sufficient time to solidify oil present in the liquid.

Various embodiments of the disclosure may be implemented with an oil-solidifying inner filter having a size and shape other than that of inner filter 418 in FIG. 6. The size and shape of the oil-solidifying inner filter may be selected based on the ability of the selected size and shape to solidify oil. For instance, some sizes and shapes may provide better contact with the oil and support a greater amount of the oil-solidifying substance than other shapes and sizes. Further, some sizes and shapes may support shutting off of the drain filter before or when the oil-solidifying effect of the oil-solidifying material is exhausted, while other sizes and shapes do not support shutting off of the drain filter. The latter shapes and sizes may support higher water flow rates and may be more suitable for filtering smaller amounts of oil such as in oil sheen.

Although one installation tool (i.e., tool 300 in FIG. 4) and one installation method was described herein, embodiments of the disclosure are not so limited. Drain filters of the disclosure may be installed using any suitable tool and any suitable installation method.

It will be further understood that various changes in the details, materials, and arrangements of the parts which have been described and illustrated in order to explain the nature of this invention may be made by those skilled in the art without departing from the scope of the invention as expressed in the following claims. For example, zip-tie 130 shown in FIG. 2 may be replaced with other suitable fasteners, including, but not limited to, string, rubber bands, twist-ties, and adhesives. As another example, drawstrings 144 and 422 may be replaced with other suitable fasteners, including zip-ties and the fasteners just described.

Unless explicitly stated otherwise, each numerical value and range should be interpreted as being approximate as if the word “about” or “approximately” preceded the value of the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A filter assembly configured to filter a liquid entering a conduit, the filter assembly comprising:
a sealing portion; and
a filtering portion coupled to the sealing portion, wherein:
the sealing portion is configured to form a seal with an inner surface of the conduit to inhibit the liquid from passing through the conduit outside of the filter assembly;
the sealing portion has a passage therethrough to permit the liquid to pass through the sealing portion into the filtering portion; and
the filtering portion is configured to allow water to pass through the filtering portion and comprises at least one of:
an oil-solidifying substance; and
a hydrophilic and oleophobic substance configured to inhibit oil from passing through the filtering portion.

2. The filter assembly of claim 1, wherein the filtering portion comprises the oil-solidifying substance.

3. The filter assembly of claim 2, wherein the oil-solidifying substance comprises one or more of a polymer sorbent, a cross-linking agent, and a polymer with cross-linking agents.

4. The filter assembly of claim 2, wherein the filtering portion is configured to prevent passage of the liquid through the filter assembly as a result of an amount of oil solidification within the filtering portion.

5. The filter assembly of claim 2, wherein the filtering portion is configured to continue to allow passage of the liquid through the filter assembly after exhaustion of an oil-solidifying effect of the oil-solidifying substance.

6. The filter assembly of claim 2, wherein the filtering portion further comprises the hydrophilic and oleophobic substance.

7. The filter assembly of claim 6, wherein the hydrophilic and oleophobic substance is selected to inhibit the flow of oil through the filtering portion for a duration that is based on a reaction time for oil solidification by the oil-solidifying substance.

8. The filter assembly of claim 6, wherein:
the filtering portion comprises a fabric outer cover; and
the fabric outer cover comprises the hydrophilic and oleophobic substance.

9. The filter assembly of claim 1, wherein the filtering portion comprises the hydrophilic and oleophobic substance.

10. The filter assembly of claim 9, wherein:
the filtering portion comprises a fabric outer cover; and
the fabric outer cover comprises the hydrophilic and oleophobic substance.

11. The filter assembly of claim 1, wherein the filtering portion comprises a non-oil-solidifying inner filter.

12. The filter assembly of claim 11, wherein the non-oil-solidifying inner filter comprises a oleophilic and hydrophobic substance configured to slow the passage of oil to an outer surface of the filtering portion.

13. The filter assembly of claim 1, wherein:
the sealing portion has a sealing edge configured to form the seal with the inner surface of the conduit;
the sealing portion has a cross-sectional area at the sealing edge; and
the filter assembly is configured to fit entirely within a space having a cross-sectional area that is less than or equal to the cross-sectional area at the sealing edge.

14. The filter assembly of claim 13, wherein:
the conduit has a cross-sectional area that is less than or equal to the cross-sectional area at the sealing edge; and
the filter is configured to be installed completely between an inlet and an outlet of the conduit, without any portion of the filter assembly protruding outside of the inlet of the conduit.

15. The filter assembly of claim 13, wherein the filter assembly comprises the oil-solidifying substance and the hydrophilic and oleophobic substance.

16. The filter assembly of claim 1, wherein:
the conduit is a scupper formed in a deck of a boat or a roof of a building; and
the filter assembly is configured to be installed completely within the scupper.

17. A filter assembly configured to filter a liquid entering a conduit, the filter assembly comprising:
a sealing portion; and
a filtering portion that is coupled to the sealing portion and configured to inhibit oil from passing through the filtering portion, wherein:
the sealing portion has a passage therethrough to permit the liquid to pass through the sealing portion into the filtering portion;
the sealing portion has a sealing edge configured to form a seal with an inner surface of the conduit to inhibit the liquid from passing through the conduit outside of the filter assembly;
the sealing portion has a cross-sectional area at the sealing edge; and
the filter assembly is configured to fit entirely within a space having a cross-sectional area that is less than or equal to the cross-sectional area at the sealing edge.

18. The filter assembly of claim 17, wherein:
the conduit has a cross-sectional area that is less than or equal to the cross-sectional area at the sealing edge; and
the filter is configured to be installed completely between an inlet and an outlet of the conduit, without any portion of the filter assembly protruding outside of the inlet of the conduit.
